(19) United States
(12) Patent Application Publication
(10) Pub. No.: US 2026/0205930 A1
(43) Pub. Date: Jul. 16, 2026

(54) DUAL NETWORK COMMUNICATIONS SYSTEM AND MODULE FOR SAME

(71) Applicant: Safariland, LLC, Jacksonville, FL (US)

(72) Inventors: Peter Hoang, Corona, CA (US); John Medine, Chino, CA (US); Ricky Calderon, Victorville, CA (US)

(21) Appl. No.: 19/450,289

(22) Filed: Jan. 15, 2026

Related U.S. Application Data
(60) Provisional application No. 63/745,642, filed on Jan. 15, 2025.

(51) Int. Cl. H04W 48/18; H04W 76/16; H04W 84/18

(52) U.S. Cl. CPC H04W 48/18; H04W 76/16; H04W 84/18

(57) ABSTRACT

A dual mode communication system selectable between at least two modes of communication, and a module for same, is provided. The system includes a user interface having at least one microphone and at least one speaker and a radio connectable to the user interface, configured to receive and send transmissions over a radio communications network. At least one mesh network module is connectable between the user interface and the radio in a first system configuration. The mesh network module has at least one transceiver and acts as a node in a mesh network. In the first system configuration, the mesh network module is configured to enable a user to select between utilizing the mesh network and the radio communications network. The mesh network module is also configured to be connected solely to the user interface in a second system configuration to thereby enable the user to utilize the mesh network.

### RELATED APPLICATIONS

Priority is claimed from U.S. Provisional Ser. No. 63/745,642 filed Jan. 15, 2025, entitled DUAL NETWORK COMMUNICATIONS SYSTEM, the entirety of which is incorporated by reference herein.

### BACKGROUND OF THE INVENTION

### Field of the Invention

The invention is directed to communication devices, and more specifically to systems and methods for increasing the flexibility and extending the range of communication networks.

### Description of Related Art

Military and first responder personnel often use radio systems to communicate with each other. Such systems typically require a central node for communication. Thus, the overall range may be limited because all communications need to go through that central node rather than directly to another user, and communications are subject to being blocked by tunnels or thick walls. Also, there are a limited number of frequencies allocated for such usage, and so there may be overlap. Latency is also an issue, and these communications are also typically not secured as by encryption.

Many radio communications systems use headsets with earcups and microphones. These are powered by a battery in the headset. One such prior art system, the Peltor Contact 6 NIB sold by 3M Company of St. Paul, Minnesota, includes a second communications system in the headset. It runs off the same battery as the primary radio communication system, however, which is undesirable because it draws down battery power faster. In this system there is no way to adjust the volume of the incoming broadcast audio, and the system is unable to extend coverage to users who are out of range of the central node, giving a limited range of perhaps only 10 meters. There is also a limited number of users who can transmit at any one time. Further, this second communications system is not separable from the headset. Thus, even if the second communications system is secure, there is a chance of inadvertently projecting non-secure wireless emissions in the secure environment over the first system.

These prior art systems, in the event of a known or suspected security breach, cannot change channels, create private groups, or provide a Type 1 encryption to try to resist breaches. There are no settings to change in a secured environment to ensure security going forward.

Some costly higher end portable radios such as Persistent Systems Wave Relay MPU5 and TrellisWare Technologies TW Shadow 950 Radio have mesh network capability for tactical communication. However, these devices have a fixed configuration, are inflexible, and cannot accommodate existing communication infrastructure (e.g., headset, PTT, single radio).

Thus there is a long-felt need to provide a communication system that does not fall prey to the above deficiencies while not being cost-prohibitive.

### SUMMARY OF THE INVENTION

The above and other objects are fulfilled by the invention, which in one embodiment is a dual mode communication system selectable between at least two modes of communication. The system preferably includes a user interface having at least one microphone and at least one speaker (for example, a headset) and a radio, connectable to the user interface, configured to receive and send transmissions over a radio communications network. At least one mesh network module is provided connectable between the user interface and the radio in a first system configuration. The mesh network module has at least one transceiver, and the mesh network module acts as a node in a mesh network. In the first system configuration, the mesh network module is configured to enable a user to select between utilizing the mesh network and the radio communications network. The mesh network is preferably encrypted via an encryption mechanism in the mesh network module.

The first connection includes at least one of a first wireless connection or a first wired connection, and the second connection includes at least one of a second wireless connection or a second wired connection.

In the first system configuration the mesh network module is configured to passively pass signals back and forth between the radio and the user interface when the user selects the radio communications network.

In a second system configuration, the mesh network module is also configured to be connected solely to the user interface. In the second system configuration, the module enables the user to utilize the mesh network.

In either system configuration, the at least one mesh network includes a plurality of the mesh network modules, each acting respectively as nodes in the mesh network, each of the plurality of mesh network modules being in communication with other of the mesh network modules in the mesh network.

The mesh network module preferably includes an internal power source independent of the radio or the user interface.

In another embodiment, the invention includes a dual mode communication system mesh network module. The module preferably includes a first connection connectable to a user interface having at least one microphone and at least one speaker and a second connection connectable to a radio configured to receive and send transmissions over a radio communications network. The module includes at least one transceiver. The mesh network module acts as a node in a mesh network. In a first system configuration, the mesh network module is configured to enable a user to select between utilizing the mesh network and the radio communications network. The mesh network module further includes an encryption mechanism that encrypts communications in the mesh network.

The mesh network module is configured to passively pass signals back and forth between the radio and the user interface when the user selects the radio communications network. The mesh network module is also configured to be connected solely to the user interface and thus enable the user to utilize the mesh network.

The mesh network module includes a plurality of the mesh network modules each acting as nodes in the mesh network, each of the plurality of mesh network modules being in communication with other of the mesh network modules in the mesh network.

The mesh network module further may include an internal power source independent of the radio or the user interface.

In another embodiment, the invention includes a dual mode communication system mesh network module. The module includes a first connection connectable to a user interface having at least one microphone and at least one speaker and at least one transceiver. The mesh network module acts as a node in a mesh network, and it is configured to enable a user to utilize the mesh network via the user interface. Optionally. the mesh network module includes an encryption mechanism that encrypts communications in the mesh network.

The mesh network module may further include a plurality of the mesh network modules each acting respectively as nodes in the mesh network, each of the plurality of mesh network modules being in communication with other of the mesh network modules in the mesh network.

The mesh network module optionally further includes an internal power source independent of the user interface.

The mesh network module optionally further includes a second connection connectable to a radio configured to receive and send transmissions over a radio communications network at the same time as being connected to the user interface. The mesh network module is configured to enable a user to select between utilizing the mesh network and the radio communications network when the mesh network module is connected to both the user interface and the radio. The mesh network module is configured to passively pass signals back and forth between the radio and the user interface when the user selects the radio communications network.

The first connection optionally includes at least one of a first wireless connection or a first wired connection, and the second connection optionally includes at least one of a second wireless connection or a second wired connection.

The invention thus relates to a dual-network communication system and a module for easily converting a single-network communication system into a dual-network communication system. The system may include a headset that can be worn by a user, the headset including earcups for listening to communications and a microphone; and a radio that can be carried by the user and that can receive and transmit radio network communications. A module is connected electrically inline between the headset and the radio, the module being configured for passing radio network communications between the headset and the radio, the module also being configured to transmit and receive mesh network communications over a mesh network.

The invention provides preferably encrypted low-latency mesh network communication without the need for a central base station. Additionally, the inventive dongle/module connects in line to standard tactical communication gear such as push-to-talk (PTT) portable radios and tactical headsets. These devices can perform their usual functions even when the inventive module/dongle is connected inline. The inventive dongle/module provides a secure secondary communication network in addition to the typical portable radio system and thus extends its range and capabilities in avoiding transmission obstacles. When the invention is activated, incoming audio that is broadcasted to it will output into the tactical headset's speakers. In addition, it can transmit audio received from the tactical headset's microphone.

In some of the attached drawings, the term Raven or Raventalk may appear. Raven and Raventalk are wireless mesh technology elements made by Digital Asset Settlement Network, LLC d/b/a Lynq. The invention is not limited to that particular company's technology.

### BRIEF DESCRIPTION OF THE DRAWINGS

FIG. 1 is a schematic of a conventional single-network communication system.

FIG. 2 is a schematic of a dual-network communication system in accordance with an embodiment of the invention.

FIG. 3 is a pictorial illustration of a communications system in accordance with an embodiment of the invention, including a headset, a single radio, a push to talk unit, and a dongle (hereinafter “module”).

FIG. 4 is a pictorial illustration of a communications system in accordance with an embodiment of the invention, including a headset and a module.

FIG. 5 is a pictorial illustration of a communications system in accordance with an embodiment of the invention, including a headset, two radios, a push to talk unit, and a module.

FIG. 6 is a block diagram of the module in accordance with an embodiment of the invention.

FIG. 7 is a block diagram of the overall incorporation of the module in a headset and radio system in accordance with an embodiment of the invention.

FIG. 8 is a perspective view of a module in accordance with an embodiment of the invention.

FIG. 9 is a block diagram of a two-channel version of the module in accordance with an embodiment of the invention.

FIGS. 10A-C are a series of block diagrams illustrating various configurations of systems in accordance with embodiments of the invention that include one or more wireless or wired connections in the mesh network module.

### DETAILED DESCRIPTION OF THE INVENTION

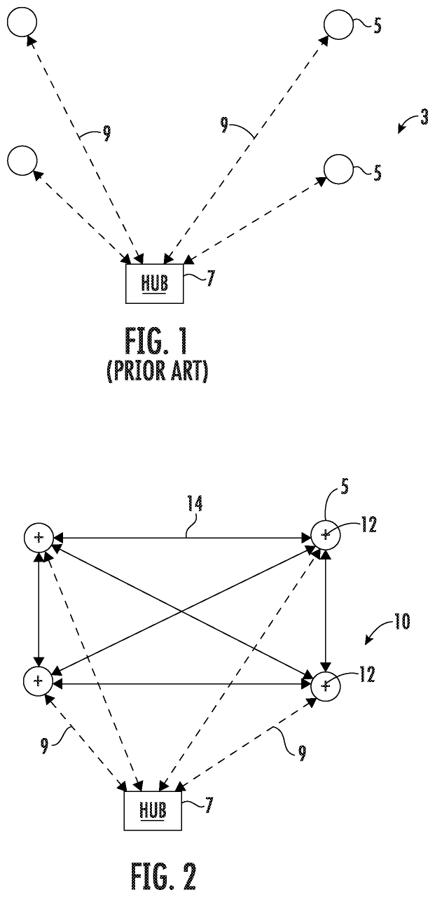

Description will now be given with reference to the attached FIGS. 1-10. It should be understood that these figures are exemplary in nature and in no way serve to limit the scope of the invention, which is defined by the claims appearing hereinbelow.

FIG. 1 is a schematic of a conventional single-network communication system 3. In system 3, users carry radios 5 which communicate with each other solely through central hub 7 via radio transmission signals 9 (schematically in dashed lines in FIG. 1). If one of the users carrying a radio 5 ventures too far from hub 7, signal 9 does not reach hub 7, and the user is cut off from the rest of the group.

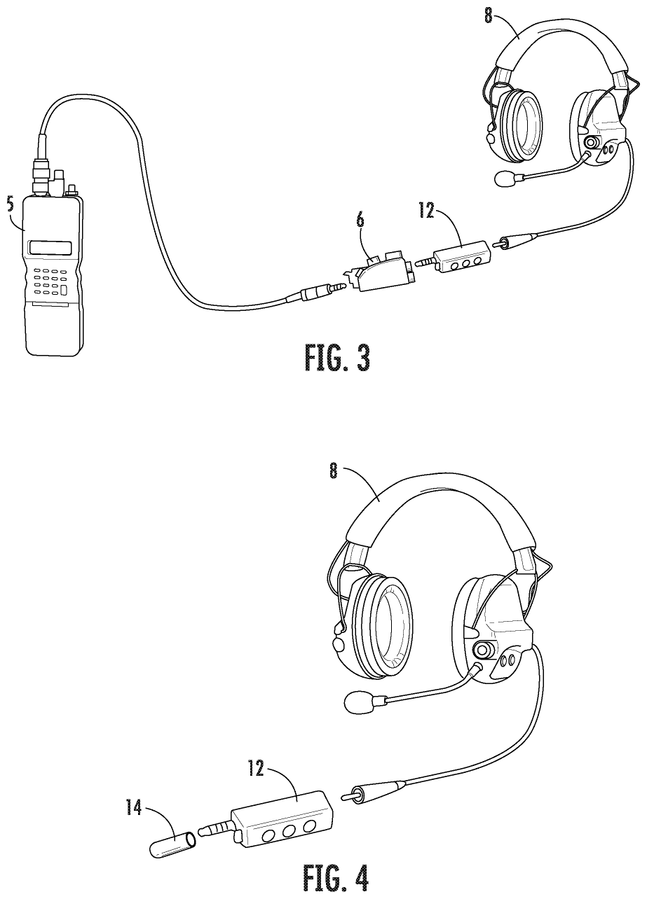

By contrast, FIG. 2 is a schematic of a dual-network communication system 10 in accordance with an embodiment of the invention. Here, radios 5 are each provided with a mesh dongle or module 12 which converts a conventional communication system into a dual-network system having additional mesh network capabilities. As a result, not only can radios 5 communicate with each other through hub 7 via signals 9, radios 5 can now also communicate with each other directly using mesh dongles/modules 12 via radio transmission signals 14 (schematically in solid lines in FIG. 2). The addition of modules 12 makes the overall system much more flexible and usable with a very small amount of additional hardware and at limited additional expense.

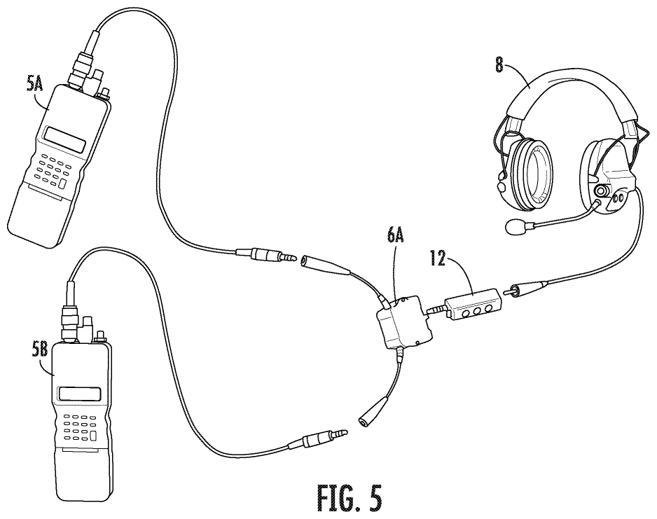

One configuration of a communication system in accordance with an embodiment of the invention is shown in FIG. 3. A user interface such as headset 8 is connected to module 12, which is in turn connected to PTT device 6. Radio 5 is connected to PTT device 6 as well. A conventional system would have headset 8 plugging into PTT device 6. With the addition of module 12, the overall system is converted from a single mode of communication (radio) to a selectively dual mode communication system (radio or mesh network).

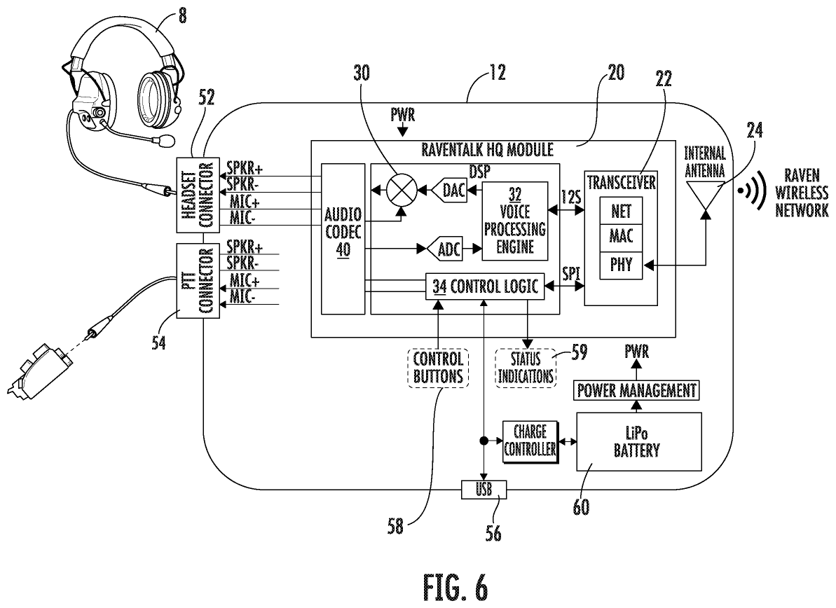

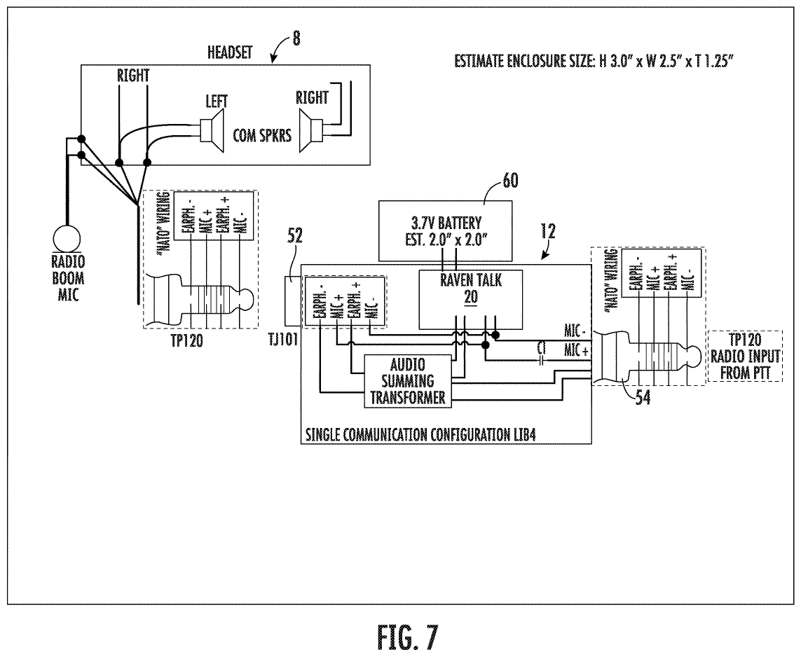

Additional use cases are illustrated. For example, in FIG. 4, headset 8 is plugged into module 12, and no radio is in use. This enables headset 8 to access the mesh network without a radio at all. Protective cap 14 may be provided to cover the plug of module 12 since it will not be connected to a radio in this configuration. This setup may be useful/preferred when users do not want to (or due to circumstances are unable to) carry large and bulky radios. In another configuration, in FIG. 5, there is shown a single headset 6 connected to a module 12, which is in turn connected to a dual PTT 6A and thence to two radios 5A and 5B.

As shown in the figures, the invention relates to a system and method for providing both a radio communications system and a mesh network communications system in the same hardware that is worn or carried by a user. The system includes a user interface such as headset 8. The headset may be a known headset that includes one or more earcups, a boom microphone, and a headset cable that connects the headset to the remainder of the system for receiving and sending voice transmissions. The headset cable terminates in a headset connector in the form of a standard four conductor plug for headset and microphone.

The system may also include radio 5. The radio is a known radio that is capable of receiving and sending transmissions over a known radio communications network. A radio cable connects the radio to the remainder of the system for receiving and sending voice transmissions over the radio communications network. The radio cable terminates in a radio connector in the form of a standard four conductor plug for headset and microphone.

The system also includes module 12 in accordance with the present invention. The module performs several functions. One function is to serve as a passthrough (a simple wire connection) for radio communications between the radio and the headset. Thus, radio communications incoming to the radio can pass through the radio cable to the module, pass unaltered through the module, then through the headset cable to the headset. These incoming radio communications are then available to the user to be heard through the earcups.

Similarly, radio communications from the user's microphone can pass through the headset cable to the module, pass unaltered through the module, then through the radio cable to the radio to be transmitted from the radio, in a known manner. Thus, the module does not interfere with or alter the existing radio communications of the user.

Another function of module 12 is to provide the user with access to a mesh network, the second communications system, separate and distinct from the radio communications network, by which the user can communicate with other users that also have modules.

The mesh network is a communications network that includes a number of nodes. Each module serves as one physical node in that network. If another user with a communications system including another module is within range, that other user (module) is also a node in the mesh network. The mesh network does not need a central hub. Each node can communicate directly with another node, or through any other node. One can simply add the module to an existing/conventional radio system.

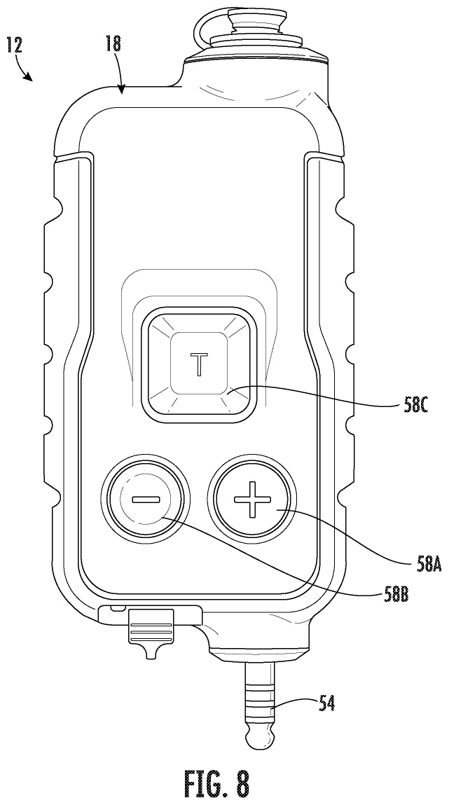

Each module 12 includes a transceiver as described below in connection with FIG. 6. When acting as a transceiver, the module communicates directly with other modules in the mesh network. The headset is electrically connected with the module via the headset cable in a manner so that the user hears and speaks normally to use the mesh communications network, without implicating the radio communications network.

If desired, the module can be removed from the system, and the headset and the radio and the PTT (if included) will still function together with the headset as a normal radio communications system.

The module has its own internal rechargeable battery and therefore does not drain the headset battery. This is an advantage of having the second communications system (the mesh network and its hardware) be separable from the headset.

When acting as transceivers, the modules communicate directly with each other; there is no need for the radios. The headset is tied into the module in a manner so that the user hears and speaks normally to use the mesh communications. The user can talk and listen simultaneously or as they choose with one or the other. The user will still hear radio communications from the radio. The microphone and speaker(s)/earcup(s) on the headset are used for both the mesh network and the radio communications system.

One beneficial aspect of the mesh system is that if the line of nodes (modules) is extended out farther, then the overall system range is increased by the fact that each node can pass on information from the previous node to a subsequent node. The mesh network does not need any central node. Any one node being out, or being blocked by tunnels or thick walls, will not necessarily affect communications over the mesh network.

The module can be set (configured by an external device) to work with only the other modules in the user's network, by setting frequencies, security settings, etc. This can be done, for example, by connecting a USB C cable between the module and a PC, then using a custom-built Graphical User Interface (GUI) that allows user to easily select and modify settings.

A beneficial aspect of the system is that the mesh network hardware is not in the headset but rather is separable from the headset. If users are in an environment in which their communications need to be extremely secure, which may not be possible with ordinary radio communications, the users can separate the radio hardware from the system and use the mesh network only. In such case, there is no longer a chance of inadvertently projecting non-secure wireless emissions in a secure environment.

The mesh network is low latency because there is no need for communications to go through a central node.

FIG. 4 shows use of the communication system without radios. Each headset 8 plugs into its own module 12. Each module 12 broadcasts and receives. All communications are via the mesh network.

FIG. 5 shows a known communication system enhanced by the inventive module 12. The system includes a standard dual radio PTT 6A and two radios 5A and 5B. In addition, the system shown in FIG. 5 includes a module 12. Headset 8 plugs into module 12, module 12 plugs into dual PTT 6A, and dual PTT 6A plugs into the two radios 5A and 5B. As a result, both mesh network and dual radio communications are enabled.

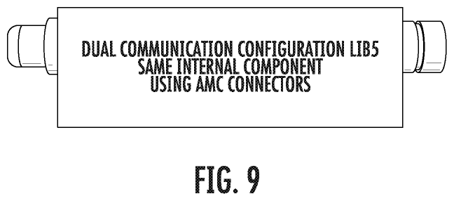

The module is a hardware module including a printed circuit board and various inputs and outputs and controls as shown in FIGS. 6 and 7. The core of module 12 is mesh submodule 20, which includes transceiver 22, digital signal processing section 30, and audio codec 40. Digital signal processing section 30 further includes voice processing engine 32 and control logic 34. One such commercially available submodule is sold by Lynq Technologies as the RavenTalk device. Module 12 also includes internal antenna 24 which allows transceiver 22 to transmit and receive signals to and from other modules 12.

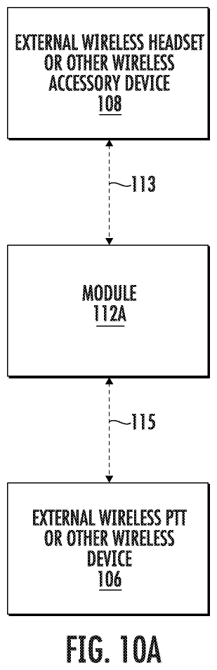

Continuing with FIGS. 6 and 7, module 12 includes headset connector 52 for enabling a user interface such as headset 8 to be plugged therein. PTT connector 54 enables connection to PTT device 6. USB port 56 is provided for externally configuring module 12 (e.g., setting which frequencies to use). Module 12 also includes control buttons 58 (to be described below in connection with FIG. 8), status indicators (e.g., power level, which mode the module is in, etc.), and internal battery 60. As shown in FIGS. 6 and 7, module 12 can receive transmissions from the microphone and send them out wirelessly over the mesh network, and can receive wireless transmissions from the mesh network and pass them to the headset earcup.

As a result, the module provides encrypted low-latency mesh network communication without the need for a central base station. The module in addition connects in line to standard tactical communication gear such as a PTT connected to portable radios and tactical headsets. These known devices can perform their usual functions even when the module is connected inline. This module provides a secure secondary communication network in addition to the typical portable radio system extends. When the module is turned on, incoming audio that is broadcast to it will output into the tactical headset's speakers. In addition, when the module is activated, it can transmit audio received from the tactical headset's microphone.

The frequencies used by module 12 are part of the DECT band. There is a rechargeable battery unit inside the module that is charged to provide power for the module, by plugging in a USB C cable that is connected to a 5V source. A red LED will shine to indicate that the unit is being charged. Even if the module is out of battery power, external accessories (tactical headsets, external radio, and PTT) will continue to function as if the module was not connected in line.

If the module has power and this is either the first time using the device, or a different group is needed to communicate with, there is a setup procedure provided. The device's parameters are set to the desired and proper settings. This can be done by connecting a USB C cable between the module and a PC and using a custom-built GUI to set audio and grouping configurations. Once the module is set to the desired setting, communication is possible via the selected operating mode (ALL TALK or PTT).

An exemplary module 12 is depicted in FIG. 8. Module 12 includes housing 18. Three control buttons 58A-C are provided, although more or fewer can be provided without departing from the scope of the invention. In this exemplary embodiment, the three buttons are 58A (plus), 58B (minus), and 58C (T). Buttons 58A and B serve to control the volume; one of them can also serve as the power on/off button via, e.g., long press functionality. Button 58C is to enable the user to speak and thus send a signal rather than merely listen.

With module 12 powered ON and headset 8 connected, the user can change the volume into the headset by quickly pressing either Button 58B for volume DOWN or Button 58A for volume UP. With each press, the user will preferably hear an audible blip in the headset. When the volume reaches its minimum level, then another press of button 58B will trigger the “MIN VOLUME” message. When the volume reaches its maximum level, then another press of button 58A will trigger the “MAX VOLUME” message.

Module 12 talk mode can be toggled between either an AllTalk mode, or the Push-to-Talk mode using, e.g., buttons 58A and C (or other combinations). When the radio is in AllTalk mode, then pressing and holding buttons 58A and C will toggle module 12 to PTT mode. Once pressed, the user can continue holding the buttons until the voice prompt, “Push-to-Talk Activated” is heard. Conversely, when the radio is in PTT mode, then pressing and holding buttons 58A and C will toggle to AllTalk mode. Once pressed, the user can continue holding the buttons until the voice prompt, “AllTalk Activated” is heard. Other button combinations are also contemplated.

When broadcasting, module 12 has the ability to extend its range using mesh topology with additional hops. A hop here is a direct communication link between multiple modules in standard range so if two modules A and C are out of standard range of each other but in between them is a module B that is in range of them the original communication will use the hop between B & C to allow communication between A & C. Thus, a user who is out of the standard range of another user will still be able to communicate under certain conditions.

The module's standard range in favorable conditions from one module to the next is around 100 meters. Using other modules as intermediaries, this can be increased with the mesh technology. The hardware for the mesh network is outside of the headset and therefore has no impact on the battery life of the tactical headset. The module offers 256 bit encryption for a transmission ensuring that an uninvited or unauthorized entity listening to that frequency will not be able to understand the transmission. In addition, the system has a feature named VAD in mode “ALL TALK” in which the module will activate a transmission based upon hearing the user's voice. Selective activation of transmission will still be possible in a loud environment that might otherwise cause a hot microphone.

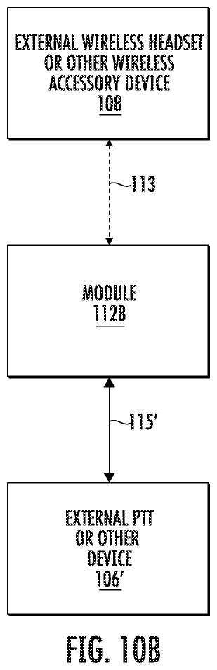

FIG. 9 is a block diagram of a two-channel version of the module in accordance with an embodiment of the invention. It is essentially the same as the module of FIGS. 6 and 7 but with two distinct audio channels (e.g., left and right).

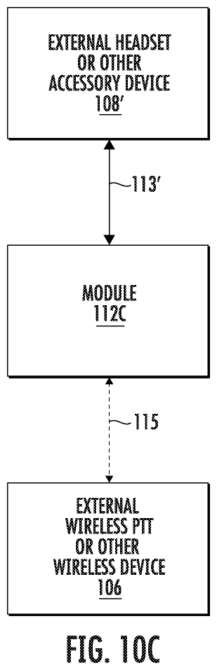

FIGS. 10A-C are a series of block diagrams illustrating various configurations of systems in accordance with embodiments of the invention that include one or more wireless or wired connections 113 and 115 in the mesh network module. In FIG. 10A-C, a dotted line with two opposing arrows represents a wireless connection, and a solid line with two opposing arrows represents a hard wired connection.

In FIG. 10A, module 112A is provided with one wireless connection 113 (e.g., Bluetooth or similar near field communication or NFC protocol, hereinafter “wireless”) to a wireless headset 108 or similar user interface and a wireless connection 115 to a wireless PTT 106 or similar other wireless device. In FIG. 10B, module 112B is provided with one wireless connection 113 to a wireless headset 108 or similar user interface and a hard wired connection 115′ to a PTT 106 or similar other device. In FIG. 10C, module 112C is provided with one hard wired connection 113′ to a headset 108 or similar user interface and a wireless connection 115 to a PTT 106 or similar other device.

The system can be used by law enforcement, and by avionic teams that are looking for a secured wireless solution to use in the back of helicopters and airplanes for internal comms without wires. The system can be used by law enforcement training facilities for range staff, instructors, and students. The system can be used by military flightline and maintenance staff, and can provide tactical teams with encrypted wireless communications for their intra-squad radio. The system can provide hazmat operators with a handsfree communication solution while wearing level A and B suits.

The system can provide fire fighters with hands free radio for constant communication during operations Portable radios at times fail to work inside high-rise structures, parking garages, underground facilities, and so forth. This system works in those facilities and the mesh network can work to expand a talk group throughout the buildings and outside for command staff. Finally, the system can be used at shooting ranges to provide wireless connectivity between staff and students while wearing ear protection headsets.

The system preferably uses the DECT frequency band which is 1920 Mhz-1930 Mhz. This is not a common frequency used for portable radios. Other modules that use the DECT frequency band would not be able to understand the communications of this system for two reasons. First, while the module uses the physical layer of DECT, the networking stack is different. Second, the system uses 256 bit encryption, and has the capability to restrict communication to a particular group (creating a “private network”) that would not allow this group to communicate with other users.

The invention thus relates to a dual network communications system, comprising a headset that can be worn by a user, the headset including earcups for listening to communications and a microphone; a radio that can be carried by the user and that can receive and transmit radio network communications; and a module that is connected electrically inline between the headset and the radio, the module being configured for passing radio network communications between the headset and the radio, the module also being configured to transmit and receive mesh network communications over a mesh network.

It should be understood that, in the context of this disclosure, “at least one of” followed by a series of elements means any one of the elements in the series or any combination of the elements in the series, including all of the elements. So, for example, a recitation of “at least one of A, B, or C” means any of A, B, C, A+B, A+C, B+C, or A+B+C.

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art.

What is claimed is:

1. A dual mode communication system selectable between at least two modes of communication, comprising:
a user interface having at least one microphone and at least one speaker;
a radio, connectable to said user interface, configured to receive and send transmissions over a radio communications network; and
at least one mesh network module connectable between said user interface and said radio in a first system configuration, said mesh network module having at least one transceiver, said mesh network module acting as a node in a mesh network,
wherein in said first system configuration, said mesh network module is configured to enable a user to select between utilizing said mesh network and said radio communications network.

2. A dual mode communication system according to claim 1, said user interface comprising a headset.

3. A dual mode communication system according to claim 1, wherein said mesh network module is configured to passively pass signals back and forth between said radio and said user interface when the user selects said radio communications network.

4. A dual mode communication system according to claim 1, wherein said mesh network is encrypted.

5. A dual mode communication system according to claim 1, wherein said mesh network module is also configured to be connected solely to said user interface in a second system configuration and, in said second system configuration, enable the user to utilize said mesh network.

6. A dual mode communication system according to claim 1, said at least one mesh network comprising a plurality of said mesh network modules each acting respectively as nodes in said mesh network, each of said plurality of mesh network modules being in communication with other of said mesh network modules in said mesh network.

7. A dual mode communication system according to claim 5, said at least one mesh network comprising a plurality of said mesh network modules each acting respectively as nodes in said mesh network, each of said plurality of mesh network modules being in communication with other of said mesh network modules in said mesh network.

8. A dual mode communication system according to claim 1, wherein said mesh network module comprises an internal power source independent of said radio or said user interface.

9. A dual mode communication system mesh network module, comprising:
a first connection connectable to a user interface having at least one microphone and at least one speaker;
a second connection connectable to a radio configured to receive and send transmissions over a radio communications network; and
at least one transceiver,
wherein said mesh network module acts as a node in a mesh network, and
wherein in a first system configuration, said mesh network module is configured to enable a user to select between utilizing the mesh network and the radio communications network.

10. A dual mode communication system mesh network module according to claim 9, wherein said mesh network module is configured to passively pass signals back and forth between the radio and the user interface when the user selects the radio communications network.

11. A dual mode communication system mesh network module according to claim 9, said mesh network module further comprising an encryption mechanism that encrypts communications in the mesh network.

12. A dual mode communication system mesh network module according to claim 9, wherein said mesh network module is also configured to be connected solely to the user interface and thus enable the user to utilize the mesh network.

13. A dual mode communication system mesh network module according to claim 9, wherein the mesh network module includes a plurality of said mesh network modules each acting as nodes in the mesh network, each of said plurality of mesh network modules being in communication with other of said mesh network modules in the mesh network.

14. A dual mode communication system mesh network module according to claim 12, wherein the mesh network module includes a plurality of said mesh network modules each acting as nodes in the mesh network, each of said plurality of mesh network modules being in communication with other of said mesh network modules in the mesh network.

15. A dual mode communication system mesh network module according to claim 9, wherein said mesh network module further comprises an internal power source independent of the radio or the user interface.

16. A dual mode communication system mesh network module according to claim 9,
wherein said first connection comprises at least one of a first wireless connection or a first wired connection, and
wherein said second connection comprises at least one of a second wireless connection or a second wired connection.

17. A dual mode communication system mesh network module, comprising:
a first connection connectable to a user interface having at least one microphone and at least one speaker; and
at least one transceiver,
wherein said mesh network module acts as a node in a mesh network, and
wherein said mesh network module is configured to enable a user to utilize the mesh network via the user interface.

18. A dual mode communication system mesh network module according to claim 17, said mesh network module further comprising an encryption mechanism that encrypts communications in the mesh network.

19. A dual mode communication system mesh network module according to claim 17, wherein said mesh network module further comprises a plurality of said mesh network modules each acting respectively as nodes in the mesh network, each of said plurality of mesh network modules being in communication with other of said mesh network modules in the mesh network.

20. A dual mode communication system mesh network module according to claim 17, wherein said mesh network module further comprises an internal power source independent of the user interface.

21. A dual mode communication system mesh network module according to claim 17, said mesh network module further comprising a second connection connectable to a radio configured to receive and send transmissions over a radio communications network at the same time as being connected to the user interface,
wherein said mesh network module is configured to enable a user to select between utilizing the mesh network and the radio communications network when said mesh network module is connected to both the user interface and the radio.

22. A dual mode communication system mesh network module according to claim 21, wherein said mesh network module is configured to passively pass signals back and forth between the radio and the user interface when the user selects the radio communications network.

23. A dual mode communication system mesh network module according to claim 17,
wherein said first connection comprises at least one of a first wireless connection or a first wired connection, and
wherein said second connection comprises at least one of a second wireless connection or a second wired connection.
